(19) United States
(12) Patent Application Publication
(10) Pub. No.: US 2005/0216376 A1
(43) Pub. Date: Sep. 29, 2005

(54) System for managing control codes

(76) Inventor: Vito Piazza, Marsala (IT)

Correspondence Address: Leffert Jay & Polglaze, PO Box 581009, Minneapolis, MN, 55458-1009, US

(21) Appl. No.: 10/505,655

(22) PCT Filed: Jan. 31, 2003
(86) PCT No.: PCT/IT03/00042

§ 371 Date: Aug. 24, 2004

(30) Foreign Application Priority Data
Mar. 7, 2002 (IT) RM2002A000126

(51) Int. Cl. G06F 17/60

(52) U.S. Cl. 705/30; 705/1

(57) ABSTRACT

System (1; 10) for managing control codes, comprising a database (2), interface means (3) for receiving a telematic communication from a user, means (4) for automatically identifying the user's telematic address, means (5) for automatically acquiring a control code, recording means (6; 60), apt to record data matching the control code in a cluster; and means (7; 70) for processing data contained in the cluster, in which said system, and in particular a central unit thereof, validates and compounds the control codes to the others matched to the same user in a database, and in which the codes may be valid as proofs of product purchase, of shopping at a sales point or of personal attendance at a given site, wherein each code may have the valence of one or more points and be employed in promotional point collection campaigns with prizes from a catalogue or of other nature.

The present invention relates to a system for managing control codes, and in particular to a system in which said codes are received and processed in a totally automated manner. Several industrial fields require dynamic managing of information related to an elevated number of users. Such a managing may be carried out assigning a respective control code to each user, and associating user-related information with such code.

For example, in most firms, medium—as well as large-sized ones, there are provided systems for controlling the daily attendance of employees at certain premises, typically based on the detection of a badge identified by a respective control code by a suitable reader.

However, in firms envisaging a certain daily movability of its employees, due to the latter travelling from a workplace to another, said system can prove quite uncomfortable and complex. Above all, this complexity is linked to the need of installing a badge reader at each workplace, programming said reader so that it be capable of transferring information on the date, the place and the time attended by the employees to a central managing unit. Moreover, in many cases the employee and the information related to the detected attendances are linked quite uneffectively, when not even manually.

Hence, the technical problem underlying the present invention is that of providing a system and a method for managing control codes allowing to overcome the drawbacks mentioned above.

Such a problem is solved by a system according to claim 1.

According to the same inventive concept, the present invention further relates to a method according to claim 9.

As it will be made apparent from the following detailed description, the system according to the invention allows to make simple and reliable the managing of control codes and, in the abovementioned exemplary application, the detection and the aggregation of employee attendance at the workplace.

Moreover, as it will be detailed hereinafter, the invention advantageously applies also to several other fields, like e.g. that of prize-point collection.

Other advantages, features, and the specific operation steps of the present invention will be made apparent in the following detailed description of some embodiments thereof, given by way of example and not for limitative purposes. It will be made reference to the figures of the annexed drawings, wherein:

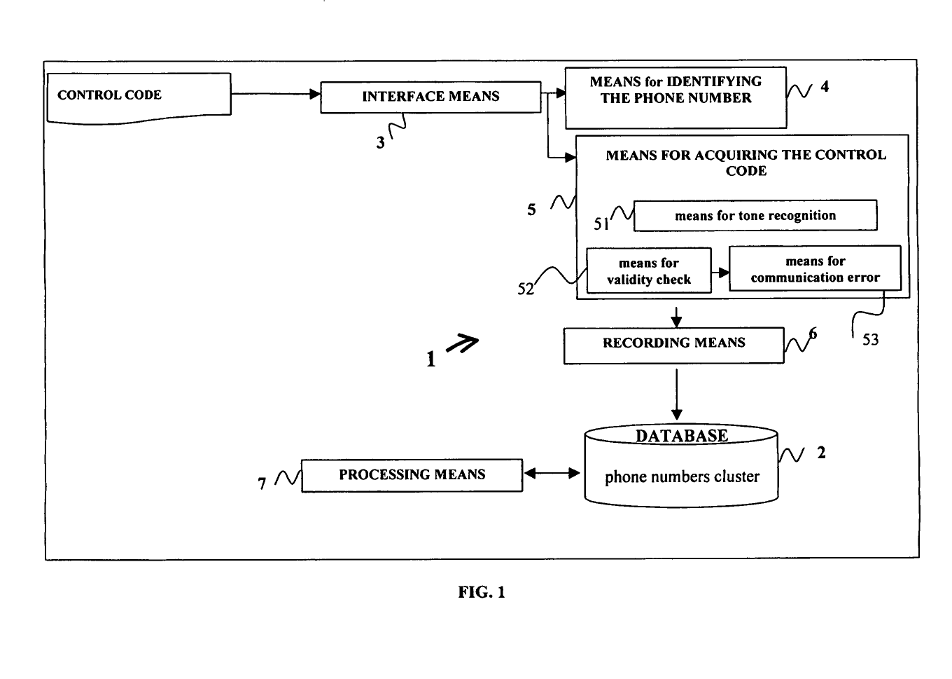

FIG. 1 shows a general block diagram of a first embodiment of the system according to the invention;

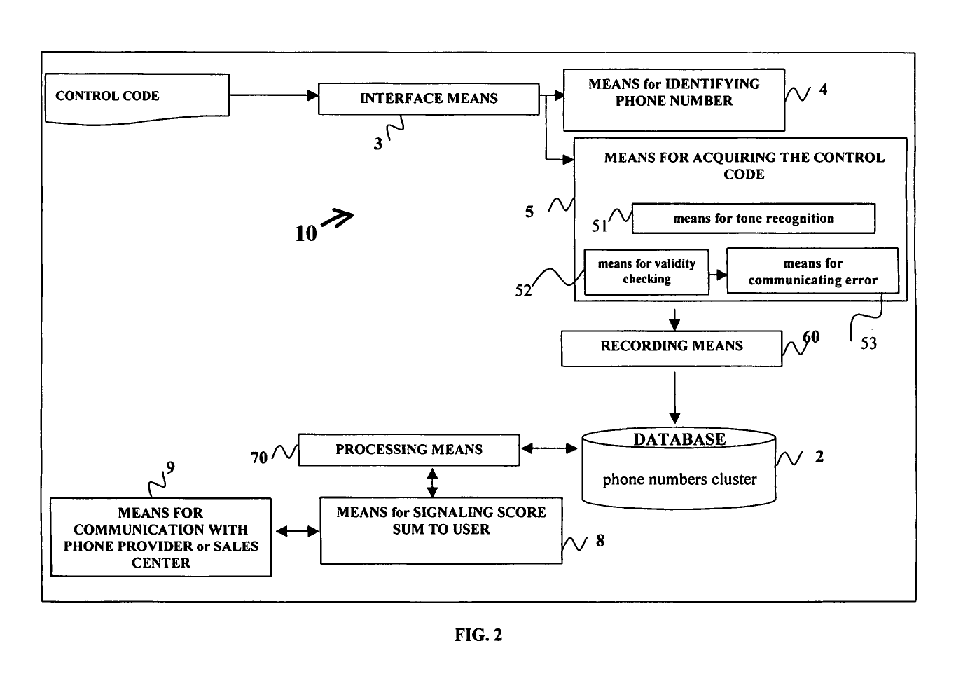

FIG. 2 shows a general block diagram of a second embodiment of the system according to the invention;

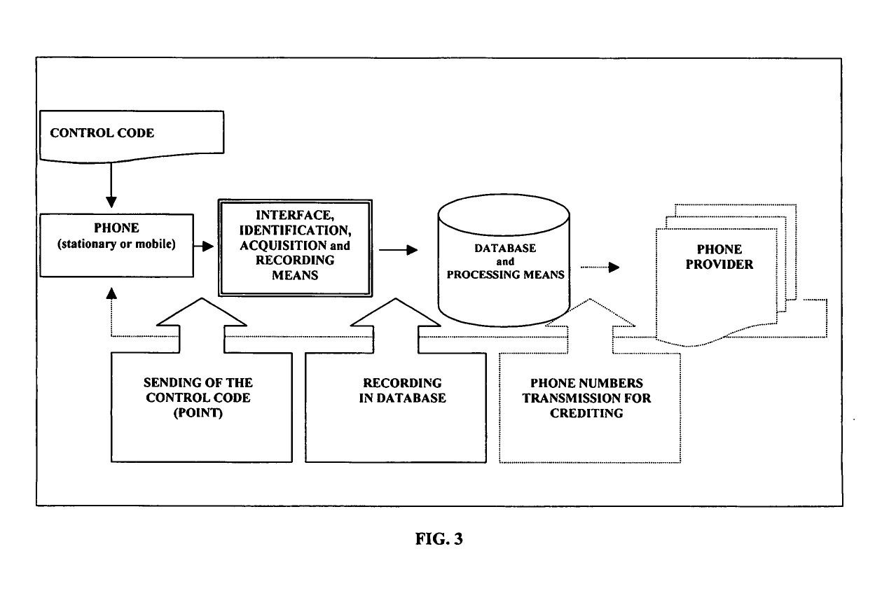

FIG. 3 shows a general block diagram related to the operation of the system of the invention; and

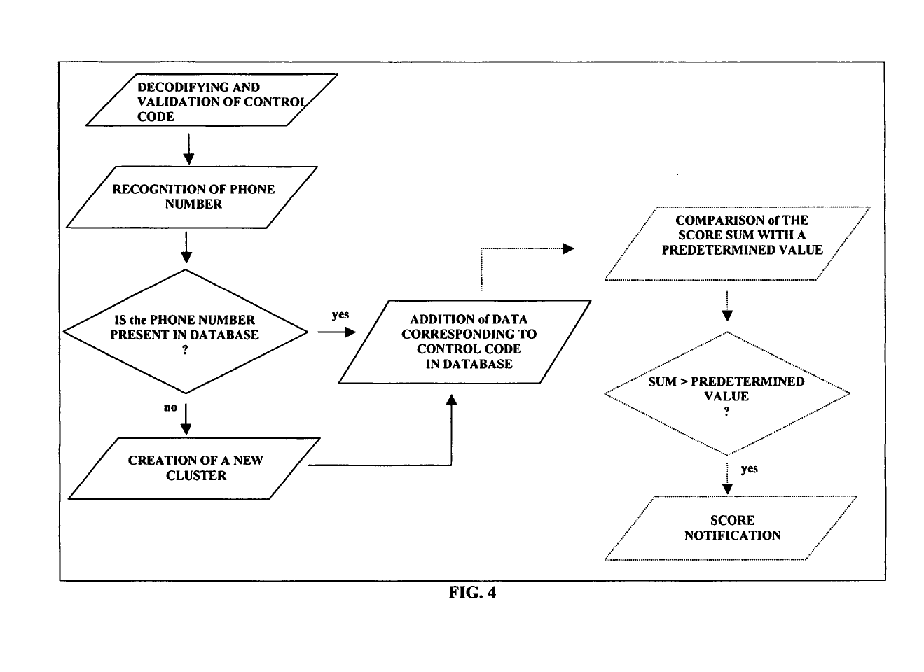

FIG. 4 shows a more detailed flow chart related to the operation of the system of the invention.

Referring initially to FIG. 1, a system for managing control codes is generally indicated by 1.

The system 1 of this first embodiment is part of a unit for controlling the attendance of firm employees at a certain workplace.

The system 1 comprises first of all a database 2, apt to store information clusters. Each cluster corresponds to one or more telematic addresses, in the present case a mobile phone number, of a user of a plurality of users, in this example firm employees.

The system 1 also comprises interface means 3, apt to enable reception of a mobile phone call from an employee.

The system 1 further comprises means 4 for automatically identifying the telematic address from which said call is effected, i.e. in the present example the employee' mobile phone number.

The system 1 also comprises means 5 for automatically acquiring a control code provided via the phone call, e.g. a numeric or alphanumeric code. This acquiring merely requires the user digiting the code via the user's phone keypad. Therefore, the acquiring means 5 in turn comprises means 51 for the recognition of the “tones” digited onto the phone keypad. A more advanced variant provides instead voice recognition means of the characters orally communicated by the same user.

The acquiring means 5 in turn comprises also means 52 for checking validity of the control code provided, and means 53 for sending an appropriate error communication to the user or for terminating the call in case of wrong code.

Variant embodiments could provide that the interface means 3 be apt to receive a telematic communication of a type differing from a phone call from a mobile or stationary phone, e.g. an SMS message or a standardized-content e-mail, or interacting via suitable websites or other interactive channels. Of course, the automatical acquiring means and/or the identification means will be modified accordingly.

The acquiring means 5 are connected to recording means 6, apt to record data corresponding to the acquired control code in a cluster corresponding to the phone address identified by said identifying means 4. As it will be detailed hereinafter, in the present embodiment such data consist of the place, date, time and other information contained in the code transmitted during the call.

Lastly, the system 1 comprises means 7 for processing data contained in each of the clusters of the database 2.

In the present embodiment, the processing means 7 are apt to produce, among other things, periodic reports required for the functionality of the attendance detection service. Such means 7 are further apt to accumulate attendances acquired for each user, as well as any other information pertaining to the working activity of the user, encoded by said control code. For example, in an alternative application a control code may be associated to each file, so as to have an employee claiming work by sending this code to the system 1 of the invention. This aspect of the invention is susceptible of telework applications.

All of the abovedescribed means are implementable by hardware and/or sofware components known to a person skilled in the art, hence a further description thereof will be omitted. In particular, the system 1 may incorporate a switchboard, capable of receiving, processing and sending standard phone calls and/or SMS from and to all mobile phones operating on different GSM, UMTS network typologies, and on any other telecommunication infrastructure, managed by a server which is active round-the-clock. Concerning SMS, as it is known, such an exchange unit may operate with a normal GSM SIM issued by any mobile telephone network provider. Such a switchboard will be capable of managing millions of incoming or outgoing calls and/or SMS. Hence, such exchange unit and server specifically implement said interface means 3, identifying means 4 and acquiring means 5.

Said server can process the switchboard operations via a “gateway” software and store the data in the database 2, thereby implementing the recording means 6 and the processing means 7.

Preferably, the system 1 is also provided with a redundancy system ensuring data duplication, so as to immediately, in case of problems, take over from the the main database 2 with a copy thereof in so-called “mirroring”.

In the case of the variant providing, among the acquiring means, voice recognition means for the characters orally communicated by a user, the exchange unit at issue is provided with a voice menu for guiding data insertion.

Hereinafter, the operation modes of the system 1 will be described additionally referring to FIGS. 3 and 4. As mentioned above, in the present application the system 1 is employed for detecting employee attendance at a certain workplace.

First of all, at workplace employees will be provided with a suitable control code. The latter is to be communicated to the system 1 in order to record in the employee's attendance thereat, or to signal any type of working activity carried out. Such codes can e.g. be printed on suitable cards.

Then, a user, provided with said code, calls a suitable telephone number, thereby contacting the system 1 and in particular the interface means 3 thereof. The identifying means 4 automatically identify the user's phone number, and the acquiring means 5 receive the code digited by the user. Then, the recording means 6 store, in a suitable cluster of the database 2, the date and time of the call, as well as a control code-associated information, which, as mentioned above, will typically consist of an attendance point at the workplace.

As it is shown in FIG. 4, when no existing cluster corresponds to the user, or—better—to the identified phone number, the recording means 6 themselves generate a new cluster, optionally after having accordingly signalled the calling user.

Then, the processing means 7 will process the received control codes in the hereto-mentioned manner.

Of course, the system for managing control codes of the invention may be employed for applications differing from the hereto-disclosed ones. In particular, the former may be employed for automatically recording prize points accumulated by proofs of purchase, or attendance at premises and places like discos, fairs and any other place typology where a person's physical presence is to be recorded.

A second embodiment of the invention, schematically illustrated in the block diagram of FIG. 2, refers to such an application. This second embodiment will be described only in the aspects differentiating it from the abovedisclosed first embodiment. In particular, in FIG. 2 alike components are indicated by the same number reference.

The system of this second embodiment, indicated by 10, comprises recording means, in this case indicated by 60, apt to associate to each acquired control code a score, and to record the latter in a suitable cluster of a database 2. Moreover, the system 10 comprises processing means 70 apt to sum the scores stored in each cluster and to determine when the sum referring to a certain cluster reaches a predetermined value.

The system 10 also comprises means 8 for signalling to the user, during the phone communication managed by the interface means 3, that the sum referring to the respective cluster has reached said predetermined value. The processing means 70 are in turn associated with means 9 for communicating, apt to communicate with a phone server to determine the automated crediting of a credit correponding to said score sum.

The other components of the system 10 are analogous those illustrated above with reference to the first embodiment.

Hence, referring also to FIGS. 3 and 4, in which the additional functions of this second embodiment of the system have been indicated by hatched blocks, it is envisaged that a manufacturing company provides its customers with control codes, e.g. transferred on coupons serving as proofs of purchase. These coupons may be contained each in a respective packaging of a certain product or product category.

Alternatively, the coupons may be individually dispensed at the counters, or, intervening on the cash till processing software, the point codes may be printed directly onto the cash slip. The cash tills, enabled to provide the point code directly onto the cash slip, associate the purchase detail references with the point code reported thereon. Upon sending the code to the system, a mere matching step will enable to associate the information related with the detail of the purchased products to the point-sending collection holder. This enables to monitor consumers' purchasing habits in detail, thereby allowing to optionally employ such data for direct marketing steps through the usually adopted means.

Therefore, in this case the users of the system 10 are the product purchasers. A user communicates the control code to the system 10 by modes analogous to those already described with reference to the abovediclosed first embodiment.

As mentioned above, the recording means 60 associate to each control code a certain prize score, which, via the processing means 70, is automatically added to any other accumulated scores. Once such sum has reached the preset predetermined value, the means 9 grant the right to collect one or more user-selected prizes, according to the rules when provided, as e.g. in the case of an automatic communication of a phone credit-prize at the phone service provider corresponding to the user's phone number. E.g., when the phone number is a mobile phone number, the actual provider shall recharge phone cards, or allow concessions or discounts on the service provided, for customers signalled by the means 9.

As mentioned above, the system 10, prior of contacting the phone service provider, can also communicate to the user, via the means 8, the reaching of said predetermined value of point sum and receive an optional prize acceptance instruction. The latter variant is particularly useful in case different prizes be envisaged for different predetermined values of point sum. In case the sum of accumulated points exceeds the prize obtainment threshold, the system may envisage that the remaining points be automatically entered for a subsequent collection. Of course, rather than the crediting of a phone credit, variant embodiments could provide the reaching of a certain score sum to result in the automatic mailing of a prize and/or of a prize certificate to the customer's address. This variant is particularly indicated in case the user accumulates the scores on a cluster corresponding to a stationary phone number, as the processing means 70 can directly identify the address corresponding to said stationary phone address by accessing a suitable public-domain database.

As mentioned above, the application for the hereto-considered prize point collection is susceptible of a variant embodiment in which the awarding of a prize provides for the physical delivery of the prize, e.g. a catalogue-selected item or even merely a discount voucher at a salespoint. In this case, in the sales center there arises the problem of identifying the consumer and of checking the actual reaching of the required point threshold thereby. For such identifying and checking, the system 10 can operate as follows.

First of all, to any sales center that has a contract for said deliveries there is associated a sales center identification code (ID code) and optionally a phone number enabled to the use of SMS or of any other telecommunication typology employed, it also referring to the managing system 10.

A prize-awarded consumer goes to an authorized sales center and communicates, by sms or other form of telecommunication sent via his/her own mobile phone, the sales center ID code to the managing system 10. Optionally, for this communication there may be provided a suitable phone number for all or each sales center, indicated in the point collection rules.

The system 10 receives the call via the interface means 3, and identifies the caller's telephone number via the means 4. Then, via the control code acquiring means 5, the system 10 reads the sales center ID code sent by the user. The code validity checking means 52 reckon this latter code identifying a salespoint and thus determine the sending thereat, via the communication means 9, of some or all the customer-related data—accumulated score included—stored in the cluster associated with the calling mobile phone number.

In order to prove the actual attendance of the prize-awarded consumer at the sales center where the prize is to be collected, the system 10 also sends to the consumer a message containing a short code (even a mere one-letter code) to be communicated to the sales center. This is useful in order to have a further confirm on the customer's side of the operation which is being performed, as well as to prevent a wrong code sent by the consumer from referring to another sales center, which could answer a message containing customer-related data and could be accredited as the one actually managing the delivery of that prize.

Then, the sales center sends to the system 10 an sms with such code orally communicated by the consumer, thereby declaring the customer's assent to detract from his/her score the amount corresponding to the prize that is being collected, and, in the case of discount vouchers, to dispose the money transfer onto its bank account of the amount that is being discounted to the consumer. In fact, in circuit campaigns such an amount is borne shared in quota parts among all the sales point whereat coupons have been acquired.

It will be understood that the hereto-mentioned additional functionalities for allowing the system 10 to check and identify the customer at the sales center may be obtained by optionally incorporating suitable hardware and/or software means additional to the hereto-described ones and apparent to a person skilled in the art.

Moreover, a further variant embodiment of the above described application envisages that the control codes/points be given to customers directly at the issuing of the product purchase cash slip, so as to have the consumer receive one or more coupons containing the codes/points due to him/her depending on the purchase. For example, at a supermarket counter, the till operator may hand out a coupon bearing a control code/point for each predetermined purchase amount, or, in general, one or more coupons referring to a plurality of control codes/points. Of course, the code on each coupon may also have a value greater than one point, and, in the computation of the accumulated score, the decoding system will take into account this intrinsic value assigned to the code.

Preferably, the code may be hidden by a scratch-off serigraph, as it is usual in scratch-and-win instantaneous lotteries, or by other code-hiding forms (envelopes, tear-off coupons, etc.). The point code could also be printed onto the cash slip emitted by the cash till, upon optional modification of the managing software thereof.

As already described with reference to the preceding application, upon having reached the score provided by the point collection rules, several prize typologies may be awarded, e.g. the automated crediting of a bonus for a virtual service like the recharge of prepaid telephone traffic, or an item to be collected at a contact sales point. This latter prize may be a physical item, or even a discount voucher for purchases at the same sales point.

Hereinafter, there will be illustrated an exemplary control code managed by the system according to the invention. As mentioned above, the code may be numeric as well as alphanumeric, and it preferably consists of two parts, an information one and a control one.

The first part should have an information content sufficing to manage the size of the expected user set.

E.g. to manage 99.999.999 users, at least 8 characters are required in a base 10 encoding, 7 characters in an hexadecimal encoding, etc., according to the formula representing the number N in base B:
N=aₖB^{k}+ . . . +a₀B⁰
(Es. 99.999.999=9·10⁷+9·10⁵+9·10⁵+9·10⁴+9·10³+9·²9·10+9),
wherein:
“B” is the base value (i.e., how many different characters are in that encoding, e.g. 10 in decimal (0, . . . , 9), 16 in hexadecimal (0, . . . , F), 36 in alphanumeric (A, . . . , Z; 0, . . . , 9)
“k+1” is the minimum number of characters required in that base to contain information sufficing to number N users.

The second part instead makes the code recognizable by a checking algorithm.

The required number of characters varies both as a function of the value of “k” and of the degree of safety to be given to the code. However, in order to be reasonably safe from the chance occurrence of a recognizable code due to a user digiting a random sequence of symbols, for the control part a≧k number of symbols is suggested.

E.g., in order to manage 99.999.999 users in a decimal encoding 8+8 characters are required. Therefore, a satisfactory algorithm for defining the control part may be given by any biunivocal function “f( )” having a (1:1) valence with the number to be encoded:
N encoding→N_{(k+1)characters} f(N)_{(k+1)characters}

The control part of the code is not necessarily positioned at the second half of the sequence: in fact, the information content remains unvaried when its characters are distributed in known positions (e.g., aaaabbbb←→aabababb).

It will presently be understood that the invention further provides a method for managing control codes, mainly comprising the steps of:
receiving a telematic communication from a user;
automatically identifying the telematic address from which the communication is effected;
automatically acquiring a control code provided via the communication;
recording, in a respective cluster of a database corresponding to the identified telematic address, information corresponding to the acquired control code.

Preferably, the telematic communication is selected from a group comprising e-mail messages, sms messages and telematic communications of any kind, in particular telephone ones from stationary or mobile phone.

In a preferred embodiment, the recording step provides the associating of a score to the control code, and the storing of said score in a respective cluster, and the method also comprises a step of processing the scores stored in the cluster in which the latter are added and the obtained sum is compared to a predetermined value.

Moreover, preferably the step of receiving a telematic communication provides the communication to the user that the sum has reached a predetermined value.

As for the rest, the preferred implementation modes of said main steps are the same hereto illustrated with reference to the system of the invention.

The present invention has hereto been described with reference to preferred embodiments thereof.

In short, the system claims the adoption of univocal codes to communicate and use as cumulable proofs of purchase in order to reach a certain score. In particular, it will be understood that, in a nutshell, the present invention refers to a system employing control codes sent to a central unit by a user. Such central unit validates said control codes, compounding them to other ones matched to the same user in a database. The codes may be valid as proofs of product purchase, of shopping at a sales point or of personal attendance at a given site. Each code may have the valence of one or more points, and be employed in promotional point collection campaigns with prizes from a catalogue or of other nature.

It is understood that other embodiments may exist, all falling within the concept of the same invention, and all comprised within the protective scope of the claims hereinafter.

1. A system for managing control codes, comprising:
a database, apt to store information clusters, wherein each cluster corresponds to a respective telematic address of a user of a plurality of users;
interface means, apt to enable reception of a telematic communication from a user;
means for automatically identifying the telematic address from which said communication is effected;
acquiring means for automatically acquiring a control code provided via said communication;
recording means, apt to record data corresponding to the control code acquired by said acquiring means in a cluster corresponding to the telematic address identified by said identifying means; and
processing means for processing data contained in each of said clusters.

2-8. (canceled)

9. A method for managing control codes, comprising the steps of:
receiving a telematic communication from a user;
automatically identifying the telematic address from which said communication is effected;
automatically acquiring a control code provided via said communication; and
recording, in a respective cluster of a database corresponding to the identified telematic address, information corresponding to the acquired control code.

10-20. (canceled)

21. The system according to claim 1, wherein said interface means are apt to receive from the user a telematic communication selected from a group comprising e-mail messages, sms messages, telephone communications from a stationary or mobile phone and other forms of telematic communication.

22. The system according to claim 1, wherein said recording means are apt to associate to each control code acquired by the acquiring means a score and to record the latter in said cluster, and wherein said processing means are apt to add up the scores contained in each cluster and to determine when the sum related to a certain cluster reaches a predetermined value.

23. The system according to claim 22, comprising means for signaling to the user, during said telematic communication, that the sum relating to a respective cluster has reached said predetermined value.

24. The system according to claim 22, comprising means for communicating with a phone provider, apt to determine the automated crediting of a credit corresponding to said score sum and associated with said processing means.

25. The system according to claim 22, comprising means for communicating with a remote sales center, apt to transmit to said sales center data contained in an information cluster of said database.

26. The system according to claim 1, wherein said acquiring means comprises verifying means for verifying validity of the acquired code.

27. The system according to claim 1, wherein to each of said clusters there corresponds a plurality of telematic addresses.

28. The method according to claim 9, wherein said telematic communication is selected from a group comprising e-mail messages, sms messages, telephone communications from stationary or mobile phone and other forms of telematic communication.

29. The method according to claim 9, wherein said acquiring step provides a checking of the validity of the acquired code.

30. The method according to claim 9, wherein said recording step provides the association of a score with the acquired control code, and the storing of said score in the respective cluster, and wherein the method also comprises a step of processing the scores stored in the cluster in which said scores are added up and the obtained sum is compared to a predetermined value.

31. The method according to the claim 30, wherein said step of receiving a telematic communication provides the communication to the user that said sum has reached said predetermined value.

32. The method according to claim 30, comprising a step of communicating with a phone provider, apt to determine the automated crediting of a credit corresponding to said score sum.

33. The method according to claim 30, comprising a step of communicating with a remote sales center, in which data contained in an information cluster of said database are transmitted to said sales center.

34. The method according to claim 9, wherein said step of recording provides the association to the acquired control code of information related to a person's attendance at a certain place.

35. The method according to the claim 34, wherein said recording step provides the association to the acquired control code of information related to an employee's attendance at a workplace.

36. The method according to claim 9, wherein to each of said clusters there corresponds a plurality of telematic addresses.

37. The method according to claim 9, comprising a preliminary step of printing the control code on a purchase coupon.

38. The method according to claim 37, wherein said step of recording provides the association with the acquired control code of information related to the effected purchases recorded in said coupon.
